(19) United States
(12) Patent Application Publication
(10) Pub. No.: US 2006/0256585 A1
(43) Pub. Date: Nov. 16, 2006

(54) Bulb assembly

(76) Inventor: Wun-Fang Pan, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,215

(22) Filed: May 10, 2005

(51) Int. Cl. H01R 33/00

(52) U.S. Cl. 362/653

(57) ABSTRACT

The invention relates to a bulb assembly of a light string, which includes a shell, a bulb holder, and a bulb. The shell is provided with an annular flange and two tongue projections. The bulb assembly can be insert into a related aperture of a plate and is engaged with the plate easily and securely. The plate with shining bulb assemblies obtains a better decorative purpose.

### FIELD OF THE INVENTION

The present invention relates to a bulb assembly of a light string, which includes an engaging structure for connecting with a plate to display a shining decorative effect.

### BACKGROUND OF THE INVENTION

Traditionally, a large support board (1) is used, as shown in FIG. 1, to connect with bulb assemblies (2) of a light string by a suitable connector (11). Each bulb assembly (2) is fixed on the support board (1) at preset position and forms a specific figure when lighting at night. In FIG. 2 of U.S. Pat. No. 6,502,958, it uses different connectors (12) to connect the bulb assembly (2) with the support board (1) for the same decorative purpose. Another U.S. Pat. No. 6,854,863 shown in FIG. 3 includes a different way to connect the bulb assembly (2) with the board (1) and provides an irregular reflecting pieces mounted on a same surface as the bulbs exposed, wherein the irregular pieces can reflect the light emitted from the bulb for shining effect.

All of the said decorations can obtain certain decorative effect. But the structure between the bulb assembly and the board is complex and lack of convenience when manufacturing. The connection is not secure enough that the bulb assembly would be easily loosened from the board.

### SUMMARY OF THE INVENTION

The present invention is to provide a bulb assembly of a light string, which includes a novel engaging structure for connecting the bulb assembly with a plate easily and firmly. Now, accompanying with the following drawings, the character of the present invention will be described here and after.

### BRIEF DESCRIPTION OF THE DRAWINGS

FIG. 1 is an exploded perspective view showing a conventional support board and a bulb assembly of a light string.

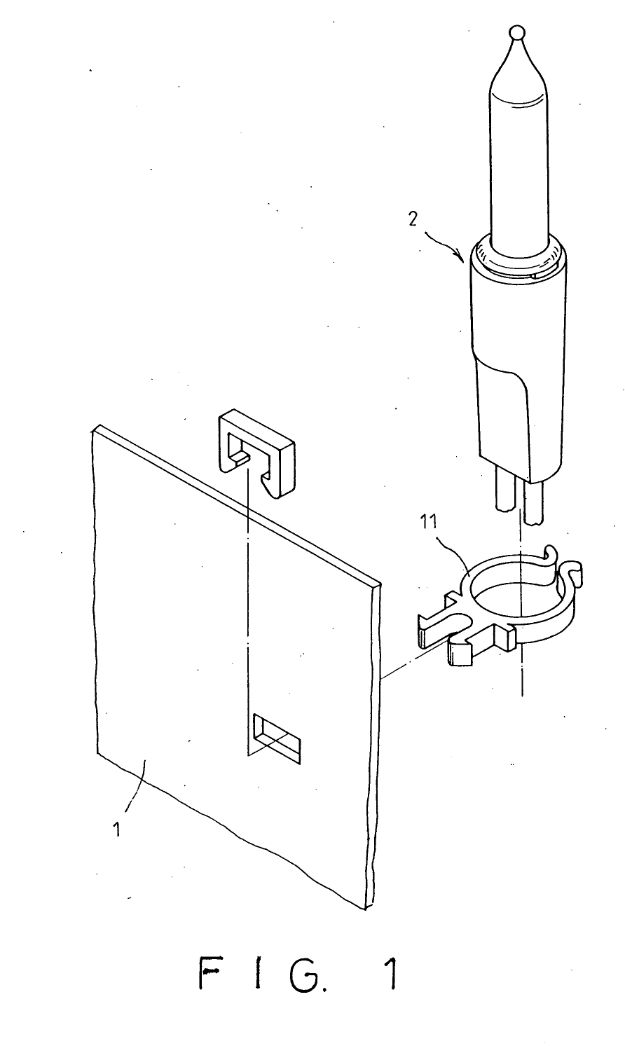

FIG. 2 is an exploded perspective view of U.S. Pat. No. 6,502,958.

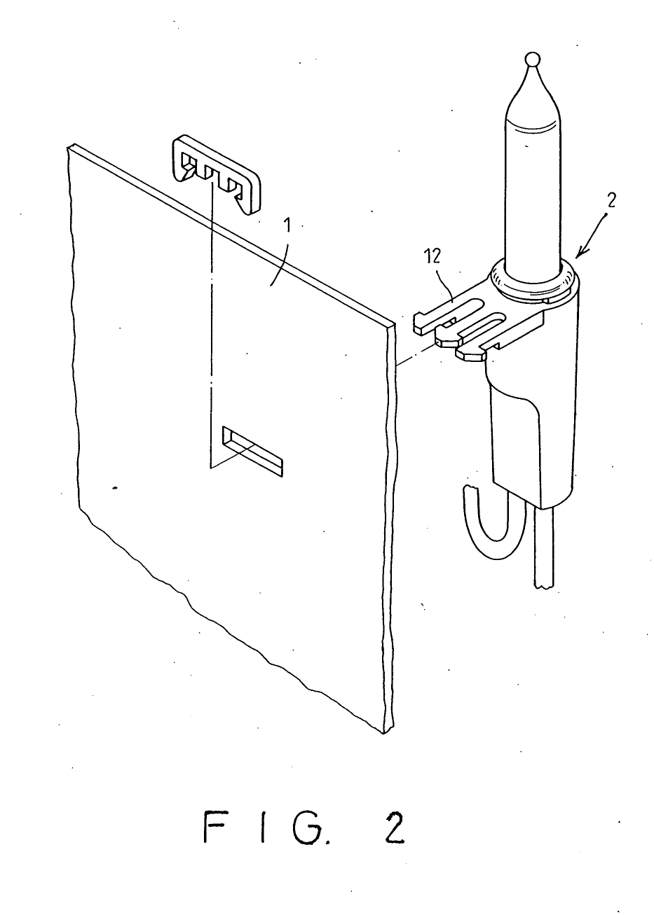

FIG. 3 is an exploded perspective view of U.S. Pat. No. 6,854,863.

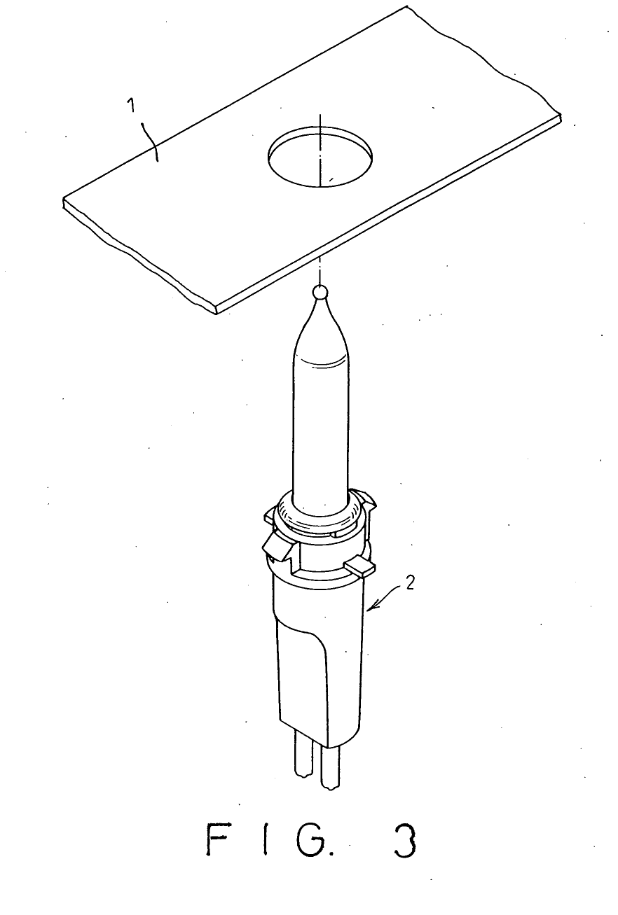

FIG. 4 is an exploded perspective view showing a bulb assembly according to the present invention.

FIG. 5 is an exploded perspective view showing a plate connecting with the bulb assembly according to the present invention.

FIG. 6 is a front cross-sectional plan view showing a part of the present invention.

### DETAILED DESCRIPTION OF THE PREFERRED EMBODIMENT

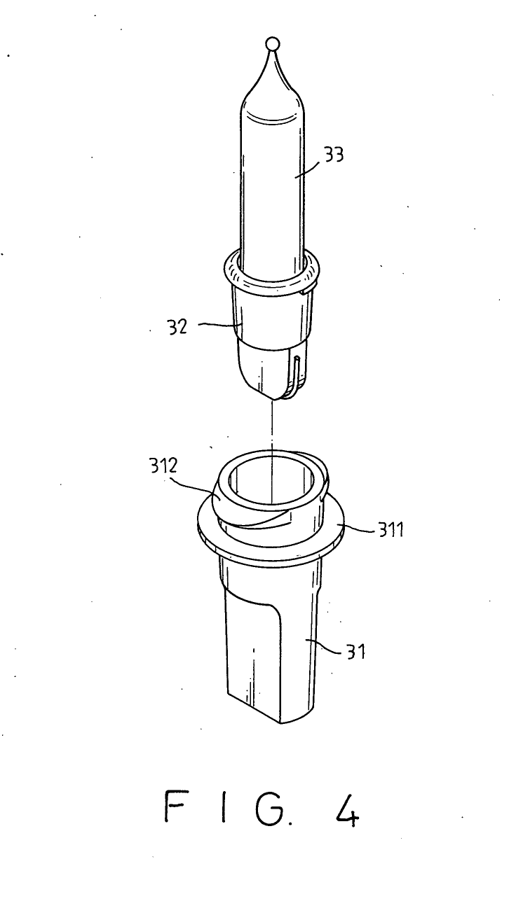

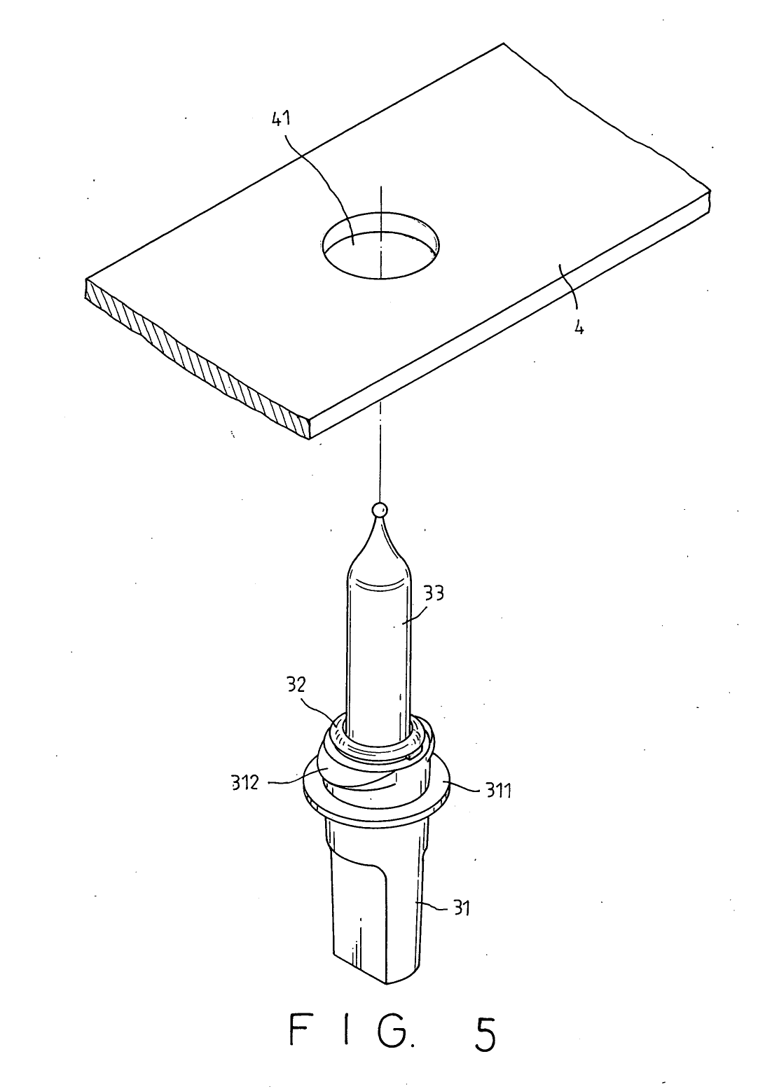

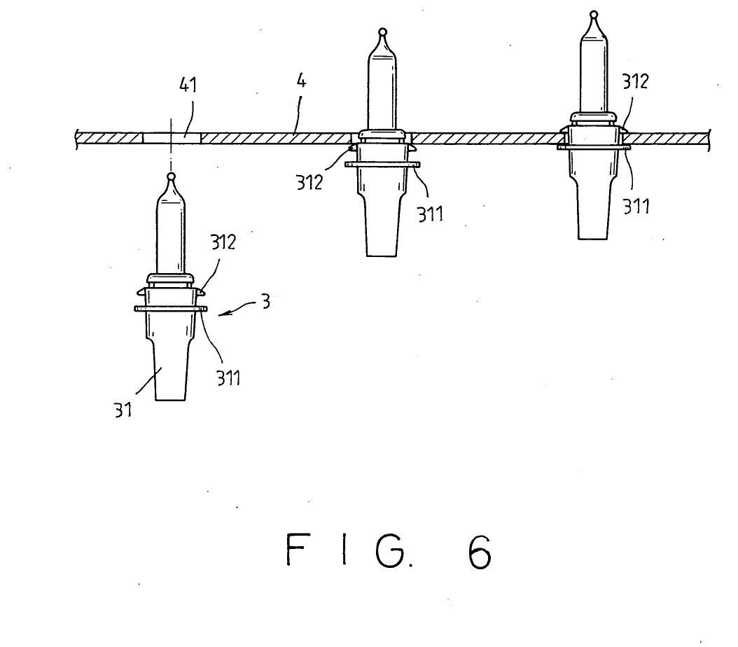

Please refer to FIG. 4 to 6, the present invention relates to an improved bulb assembly of a light string. The bulb assembly includes a shell (31), a bulb holder (32), and a bulb (33). The shell (31) is provided with an outer annular flange (311) and two opposite tongue projections (312), which has an inclined upper face and a lower horizontal plane.

When the bulb assembly (3) of the present invention is to connect with a plate (4), the bulb assembly (3) is able to be insert into a related aperture (41) of the plate (4). Since the tongue projection (312) is made of plastic with an elastic character, the inclined face of the tongue is very easy to pass through the aperture (41) of the plate (4). And the plate (4) is thus engaged between the tongue (312) and the flange (311) of the shell (3). In such status, the connection will be obviously firm and secure.

Accordingly, the bulb assembly of the light string of the present invention will be more convenient to be engaged with the plate in secure. It should be allowed for patent.

I claim:

1. A bulb assembly of a light string including a shell for receiving a holder and a bulb therein, which is engaged with a relating aperture of a plate to obtain a shining decoration, wherein the shell is provided with an outer annular flange and two opposite tongue projections, which include an upper inclined face and a lower horizontal plane, and the bulb assembly being insert into the aperture of the plate for firm connection, while the plate is positioned in secure between the tongue projections and the annular flange.
